(19) United States
(12) Patent Application Publication
(10) Pub. No.: US 2004/0084096 A1
(43) Pub. Date: May 6, 2004

(54) Water supply medicator

(76) Inventor: T. Keith Whaley, Cullman, AL (US)

Correspondence Address: Wm. Randall May, Allison, May, Alvis, Fuhrmeister,, Kimbrough & Sharp, 1300 Corporate Drive, Birmingham, AL, 35242, US

(21) Appl. No.: 10/287,972

(22) Filed: Nov. 6, 2002

(51) Int. Cl. F17D 3/12; A01K 7/00

(52) U.S. Cl. 137/624.13; 119/72

(57) ABSTRACT

A method and apparatus for providing the sequential delivery and timed release of measured amounts of additives to the water supply of livestock or plants is disclosed. The invention uses a direct injection method to meter and deliver fresh and accurate dosages of additives to a supply of water through the use of a timing mechanism operably attached to a flow control valve.

### BACKGROUND

This invention relates generally to water treatment systems and more specifically, though not exclusively, to a method and apparatus for providing, in timed sequence, measured amounts of additives, such as antibiotics, vitamins, nutritional supplements and disinfectants, to the water supply of livestock.

The first livestock water supply medication device was developed some thirty years ago when a farmer mounted a large drum onto an elevated stand outside his barn and allowed gravity to deliver a mixture of water and medicines to the farm animals inside his barn. As the poultry and livestock industry grew and became more sophisticated, and the genetics of the animals continued to change, the need to deliver medicines and supplements to the animals with more precision became paramount. Since the advent of the first crude medicator device, it has become a universal practice in the poultry and livestock industry to use the stock watering system as a carrier to deliver medications, supplements, disinfectants and other drugs and/or chemicals to the animals for the prevention of diseases and for proper hygiene, care and development of the animals. Additives such as aspirin, vinegar, iodine, hydrogen peroxide, chlorine, antibiotics, vitamins, nutritional supplements and live bacterial mixtures are now routinely delivered to poultry and livestock through the stock watering system of the farm or commercial livestock facility. However, certain mixtures of supplements or additives, particularly solutions containing chlorine, are very corrosive causing damage to, and limiting the life of, delivery systems which utilize corrodible components such as pumps, pistons, washers, pins, diaphragms, o-rings, and the like.

Known prior art devices, such as those disclosed in applicant's information disclosure statement submitted herewith, employ mixing chambers or mixing zones, complicated valve systems, and filtering systems having many moving parts and having components which are very susceptible to corrosive agents. Generally, in most of these systems, fresh water is pumped or otherwise caused to be introduced into one or more valved mixing chambers or mixing zones where the water is caused to be mixed with concentrated medicants and/or supplements. Proper delivery, control and maintenance of the dosage or concentration of the medications or supplements being continuously introduced into the water supply through such means is at best difficult, if not impossible.

Controlled delivery, proper dosage and timely consumption of medicants is particularly crucial when live bacterial solutions are introduced into the water supply of such systems. The use of a stock watering system to deliver water vaccinations is the most practiced method of administering vaccines to livestock, especially poultry stock. However, the bacteria used for poultry and livestock vaccination or treatment generally have very short life spans (some bacteria in certain vaccines have a lifespan of only 2 to 3 hours) and therefore the delivery of such vaccines to the poultry or livestock quickly and in the proper dosage is imperative. Furthermore, improper dosages, improper mixing or over dilution of the vaccine solution tends to weaken the vaccine thereby causing the vaccine to quickly deteriorate. It is also critical that “fresh” vaccine be delivered to the livestock in a timely manner as organisms within the vaccine begin to die if the vaccine solution is not timely consumed, becomes too warm or is exposed to light. Some vaccines lose fifty percent of their potency within one hour under adverse conditions. Timely delivery of fresh dosages of additives, particularly live bacterial solutions, for immediate consumption by the animals is therefore essential.

Existing livestock water supply medicator systems in use today cannot provide the accuracy, dependability or timed delivery of additives necessary to insure proper medication and treatment of the livestock. It would be expedient, therefore, to provide an improved method and apparatus for administering and delivering accurate, timely and fresh dosages of additives to the water supply of livestock. It would also be desirable if said method and apparatus could be adapted for use within the botanical industry. The present invention provides an accurate, dependable, simplified and cost effective solution to the problems associated with the prior art within the livestock industry and provides a method and apparatus adaptable for use in both the livestock and botanical industry.

### SUMMARY OF THE INVENTION

In view of the foregoing, it is a primary object of this invention to provide a method and apparatus for the sequential delivery and timed release of measured amounts of additives to the water supply of livestock or plants. Further, it is also a primary object of the present invention to provide method and apparatus that is capable of delivering fresh and accurate dosages of additives to a supply of water through the use of timing device connected to a flow control valve.

According to an embodiment of the invention, an apparatus for sequential delivery and timed release of additives to the water supply of livestock or plants comprises an electrical timing means connected to a solenoid-type valve for controlling of the flow of water through the water supply pipe serving livestock drinking stations or botanical watering facilities and includes a means for adjustably metering and directly injecting additives into the water supply.

A primary advantage of the present invention is the provision of a water supply medicator that can deliver accurate doses of additives to a water supply, automatically shut off the flow of water until the medicated water is substantially consumed or used, and then replenish the water supply with freshly medicated water.

Another advantage of the present invention is the provision of a water supply medicator which uses a timed delivery, direct injection process that eliminates the need for mixing chambers or mixing zones.

A further advantage of the present invention is the provision of a water supply medicator for livestock water systems that quickly dispenses fresh medications or supplements to animal drinking stations and allows the mixture to be consumed before automatically dispensing a fresh supply of medicated water.

A further advantage of the present invention is the provision of a water supply medicator that is inexpensive to produce, very durable and has minimal maintenance costs.

An important advantage of the present invention resides in the fact that the device has virtually no moving parts and does not use corrodible parts such as pumps, pistons, diaphragms, bladders, o-rings, washers, or pins.

Another important advantage of the present invention resides in the use of an adjustable metering means which can accommodate a wide range of water pressures and that allows proper dosages of medications or supplements to be easily and accurately injected into the water supply.

Another advantage of the present invention resides in the infinite number of timer settings available for delivery of medicated water to drinking stations or watering lines.

A further advantage of the present invention is the provision of a water supply medicator wherein the mixing of water and additives occurs during the injection process.

A further advantage of the present invention is provision of a water supply medicator for livestock watering systems which can accommodate animals, particularly birds, from a just a few ounces in weight to many pounds by simply changing the metering means to adjust the dosage and by adjusting the run time on the timing device.

### BRIEF DESCRIPTION OF THE DRAWINGS

The foregoing and other objects, features, and advantages of the present invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a perspective view of a preferred embodiment of the invention shown connected to a typical water supply.

FIG. 2 is a plan view of a preferred embodiment of the invention.

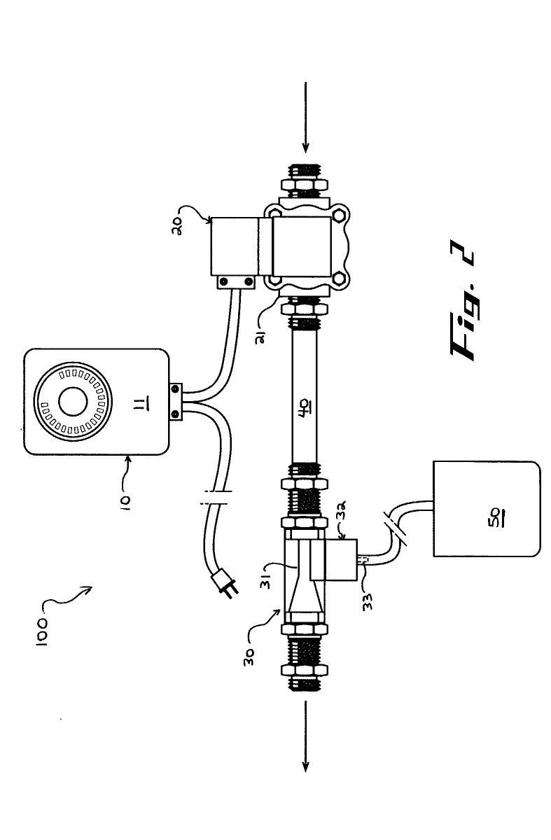

### DETAILED DESCRIPTION OF THE DRAWINGS

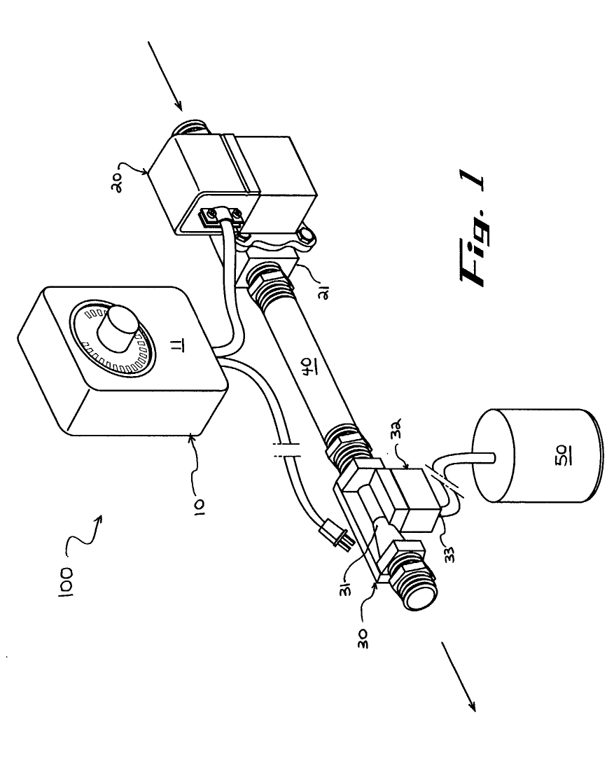

In accordance with an embodiment of the invention, FIG. 1 shows a water supply medicator system 100 operably attached to a typical water supply pipe 40 and comprising an electrical timing means 10, an electrically operated flow control means 20 activated by said timing means 10, and an injector means 30 for injecting metered dosages of a medication or additive 50 directly into the water supply pipe 40 during water flow.

The timing means 10 of the present invention is a simple “off-the-shelf” electrically operated timer mechanism 11 which can be programmed to turn one or more low voltage devices on or off at various preset intervals. The electrically operated flow control means 20 of the present embodiment is operably connected to the timer mechanism 11 of said timing means 10 and comprises a typical 2-way, normally closed, solenoid-type flow control valve 21 designed for on/off control of the flow of water through said valve 21.

The injector means 30 of the present invention comprises an in-line, water-powered, proportioning valve 31 and a flow metering means 32 operably attached to said proportioning valve 31. The injector means 30 has no moving parts and is controlled by the velocity of water flowing through the proportioning valve 31. The flow of water through the proportioning valve 31 of the injector means 30 creates a Venturi principle vacuum which is used to pull medications or additives 50 through the metering means 32 and into the proportioning valve 31 whereby said medications or additives 50 are injected into the water stream flowing through said proportioning valve 31. The amount of medications or additives 50 allowed to enter the proportioning valve 31 is dependent on the water pressure of the incoming water supply and is controlled by the metering means 32. The metering means 32 of the injector means 30 controls the feed rate of the medication/additive 50 into the proportioning valve 31 through the use of calibrated metering nozzles or tips 33. Calibrated metering tips 33 are available commercially for a wide range of injection rates and liquid viscosities and may be color-coded for quick and accurate replacement as necessary.

In operation, an appropriate metering tip 33 is selected for use with the proportioning valve 31 of the injector means 30 depending on the water pressure of the incoming water supply and the dosage rate of medicant/additive 50 required to be added to the water supply. The timer mechanism 11 of said timing means 10 is then programmed to activate the electrically operated flow control means 20 to open the flow control valve 21 and thereby allow water to flow through the system 100 for an interval sufficient to meet the watering needs of the particular application. For example, for livestock watering purposes, the timer mechanism 10 would be set to cause the flow control valve 21 to open for a sufficient amount of time necessary to allow the injection means 30 to inject the water with an appropriate dosage of medicant/additive 50 and to fill the drinking lines of the livestock watering stations with the freshly medicated water. The timer mechanism 11 would then cause the flow control valve 21 to close or shut off the water supply for a predetermined period of time sufficient to allow the animals being treated to substantially consume the freshly medicated water. Once the animals have had an opportunity to substantially consume the freshly medicated water, the process is repeated and a fresh supply of medicated water is caused to fill the drinking lines of the livestock watering stations. This process is continued as long a necessary for proper treatment of the animals. The on/off interval of time programmed into the timing means 10 to automatically open and close the electrically operated flow control valve 21, and thereby control the flow of water through the injector means 30 and into the drinking lines of the livestock watering stations, is dependent on the size and number of animals being treated and the propensity of the animals to consume the medicated water. For instance, very small animals, such as baby chickens up to two weeks of age, do not consume very much water and the on/off interval of the timing device 10 would be adjusted to allow sufficient time for these animals to consume the medicated water before a fresh dosage is automatically reintroduced into their drinking lines. Larger animals, such as large birds, cattle or swine, consume water at a faster rate and the on/off interval of the timing means 10 would be adjusted accordingly. On/off intervals such as 15 seconds “on” out of a 5-minute period for very small animals to 4.5 minutes “on” out of a 5-minute period for larger animals are typical. The present invention can be programmed to accommodate the watering and medication needs of animals from just a few ounces in weight to many pounds in weight by simply changing the calibrated metering tip 33 of the metering means 32 and adjusting the run time of the timing means 10.

The present invention, as described, can also be adapted and programmed for botanical use to supply measured amounts of nutrients and supplements to the water supply of plants or crops on a timed-release basis.

While the invention has been particularly shown and described with reference to the preferred embodiments thereof, it will be understood by those skilled in the art that various alterations in form, detail and construction may be made therein without departing from the spirit and scope of the invention.

The embodiments of the invention in which an exclusive property right or privilege is claimed are defined as follows:

1. An apparatus for administering and delivering accurate, timely and fresh dosages of additives to a liquid flowing through a pipe comprising:
a timer means for controlling the on/off cycles of one or more processes;
a flow control means operably attached to said timer means for controlling the flow of the liquid through the pipe; and,
a injection means located downstream of said flow control means for introducing a measured amount of additive into the liquid flowing through said pipe.

2. The apparatus of claim 1, wherein said timer means is electrically operated.

3. The apparatus of claim 1, wherein said timer means causes said flow control means to open the flow of said liquid through said pipe for a predetermined interval of time and then to stop the flow of said liquid through said pipe for predetermined interval of time.

4. The apparatus of claim 3, wherein the timer means is programmed to repeat the time interval cycle of opening the flow of liquid through said pipe and then stopping the flow of said liquid through said pipe.

5. The apparatus of claim 1, wherein said flow control means comprises an electrically operated valve.

6. The apparatus of claim 5, wherein said flow control means comprises a solenoid-type valve.

7. The apparatus of claim 1, wherein said injection means comprises an in-line, Venturi-type proportioning valve and a metering means for controlling the injection rate of additives being introduced into said liquid.

8. The apparatus of claim 7, wherein said metering means adjustably controls the feed rate of additives entering the proportioning valve.

9. The apparatus of claim 7, wherein said metering means further comprises one or more interchangeable calibrated flow restriction nozzles.

10. A method of administering and delivering accurate, timely and fresh dosages of additives to liquid flowing through a pipe comprising the steps of:
attaching a flow control means to said pipe,
attaching a timer means to said flow control means for activation of said flow control means, and,
attaching an injection means to said pipe downstream of said flow control means for introducing a measured amount of additive into the liquid as it flows through said pipe.

11. The method of claim 10, wherein said flow control means comprises an electrically operated valve.

12. The method of claim 11, wherein said flow control means comprises a solenoid-type valve.

13. The method of claim 10, wherein said timer means is electrically operated.

14. The method of claim 10, wherein said timer means causes said flow control means to open the flow of said liquid through said pipe for a predetermined interval of time and then to stop the flow of said liquid through said pipe for predetermined interval of time.

15. The method of claim 10, wherein the timer means is programmed to repeat the time interval cycle of opening the flow of liquid through said pipe and then stopping the flow of said liquid through said pipe.

16. The method of claim 10, wherein said injection means comprises an in-line, Venturi-type proportioning valve and a metering means for controlling the injection rate of additives being introduced into said liquid.

17. The method of claim 16, wherein said metering means adjustably controls the feed rate of additives entering the proportioning valve.

18. The method of claim 16, wherein said metering means further comprises one or more interchangeable calibrated flow restriction nozzles.
